(19) United States
(12) Patent Application Publication
(10) Pub. No.: US 2017/0142578 A1
(43) Pub. Date: May 18, 2017

(54) SYSTEM AND METHOD FOR PROVIDING SECURE AND ANONYMOUS DEVICE-TO-DEVICE COMMUNICATION

(71) Applicant: Yaana Technologies LLC, Milpitas, CA (US)

(72) Inventors: Rajesh Puri, Fremont, CA (US); David Grootwassink, Safety Harbor, FL (US); Michael P. Hammer, Reston, VA (US)

(73) Assignee: Yaana Technologies LLC, Milpitas, CA (US)

(21) Appl. No.: 15/350,996

(22) Filed: Nov. 14, 2016

Related U.S. Application Data
(60) Provisional application No. 62/255,358, filed on Nov. 13, 2015.

(51) Int. Cl. H04W 12/02; H04L 12/58; H04W 4/12; H04M 1/725; G06F 21/57; H04W 12/04; H04W 76/02; H04L 29/06; G06F 9/44; H04L 29/08; H04W 8/18

(52) U.S. Cl. CPC H04W 12/02; H04L 67/1063; H04L 67/02; H04L 51/28; H04W 4/12; H04M 1/72552; H04W 8/183; H04W 12/04; H04W 76/023; H04L 63/061; H04L 63/0838; G06F 9/4401; G06F 21/575

(57) ABSTRACT

A system and method for establishing secure and anonymous communication between multiple devices. The system includes a first device operating a communication application that it may be downloaded from a private web site, and a second device operating the communication application. The system also includes a server in communication with the first device and the second device. The first device sends a request to the server to connect with the second device, and the server relays the request to connect to the second device. The second device may then send an acceptance of the request to connect to server, and the server relays the acceptance to connect to the first device. Thereafter, a direct connection may be established between the first device and the second device.

### CROSS-REFERENCE TO RELATED APPLICATIONS

This application claims the benefit of U.S. Provisional Application No. 62/255,358, filed Nov. 13, 2015, which is herein incorporated by reference in its entirety.

### BACKGROUND

Recently, a demand for secure mobile communication alternatives has grown due to revelations regarding government global surveillance programs, an increase in cyber-attacks, and the collection and monetization of personal data. A typical communication application may have shortcomings and may be compromised within a short amount of time. Furthermore, users such as government officials, business executives, journalists, university students, and healthcare professionals may have the need to share information with other users privately and securely. In the secure communication industry, a typical communication application may contain a weak implementation of security such as providing an intermediate communication infrastructure, thus leaving the communication application open to compromise.

Therefore, what is needed, is a system and method that provides server-less communication between two devices that is secure and easy to use.

### SUMMARY

Briefly, and in general terms, various embodiments are directed to a method for providing secure communication between a first device and a second device. The method includes establishing a connection between the first device and a server, and sending a request to the server from the first device to connect with the second device. Also, the method includes sending the request to connect with the second device from the server to the second device, and sending an acceptance of the request to connect from the second device to the server. The acceptance of the request to connect to the second device may then be sent from the server to the first device. A direct connection is established between the first device and the second device without the need for communication with the server in between the first device and the second device.

Another embodiment is directed to a system for secure communication between multiple devices. The system includes a first device operating a communication application that it may be downloaded from a private web site, and a second device operating the communication application. The system also includes a server in communication with the first device and the second device. The first device sends a request to the server to connect with the second device, and the server relays the request to connect to the second device. The second device may then send an acceptance of the request to connect to server, and the server relays the acceptance to connect to the first device. Thereafter, a direct connection may be established between the first device and the second device.

Other features and advantages will become apparent from the following detailed description, taken in conjunction with the accompanying drawings, which illustrate by way of example, the features of the various embodiments.

### BRIEF DESCRIPTION OF THE DRAWING

FIGS. 1 and 2 depict exemplary diagrams for providing a secure and anonymous device-to-device communication.

FIG. 3 depicts an exemplary user interface for receiving touch input in a specific shape.

FIG. 4 depicts an exemplary computer architecture that may be used for one embodiment of communication system.

### DETAILED DESCRIPTION

The present disclosure describes a system and method for providing secure and anonymous device-to-device communication that provides server-less communication, anonymity, quick set-up, high key exchange, no backdoors, automatic deletion of messages, and military encryption. The present system and method provides a secure communication application for use on various platforms, including, but not limited to, ANDROID™, IOS™, WINDOWS PHONE™, and desktop operating platforms. The present system and method provides a secure communication application for users that require highly secure communication and a desire for maximum privacy and confidentiality.

According to one embodiment, the present system provides a secure communication application that may be downloaded and installed by a user onto a device, such as a mobile phone, tablet, laptop, or other computing device. It has been contemplated the present communication application is not available for download through a public app store (e.g., Apple's App Store or Google Play Store) and is instead only available for download by visiting a privately available URL from a web browser on the mobile device itself. The communication application, however, may be downloaded from public app stores in other embodiments. Setup of the application once downloaded on the user's device is relatively quick because the communication application would only require a user select how long sent messages will last after being viewed by another user. This auto-delete feature may or may not be selected by a user. As part of the setup, the user may be required to choose a mask or image and a password. The user may also have to decide if the communication application should auto-lock after the device or application is inactive for a desired amount of time.

The present system and method provides a secure communication application that uses an encryption process and an exchange process that eliminates server reliance for content storage and provides a direct device-to-device communication between users of varying geographic distance or location. The present secure communication application provides secure and anonymous exchange of data between users. According to one embodiment, the present secure communication application may be provided to a user based on a subscription service.

According to one embodiment, the present system provides anonymous direct device-to-device communication. Each communicating device may be anonymous, i.e., the present system does not require a user to register a user account, create a username that is stored in a database, or provide any personally identifiable information. In this embodiment, the user is able to select a mask (e.g., an image) that is displayed to the user's contacts along with a name chosen by each of the user's contacts. Allowing users to assign names to other paired users on their devices ensures that the environment remains anonymous.

The present system may not require an intermediate server or infrastructure for communications content in one embodiment. The present system uses an encryption method and key generation process. In certain embodiments, standard, well-vetted encryption methods are used, such as the Advanced Encryption Standard (AES) which can use 128, 192, or 256-bit key sizes. Other encryption methods may also be used. More specifically, it may be preferred to use AES-256 with CBC cipher-suite Encryption as the symmetric keys, and elliptic curve Diffie-Hellman as the key agreement. For instant messaging and file transfer channels, Elliptic Curve-secp384r1 with AES 256 may be used for asymmetric keys. For voice channels, Elliptic Curve-secp384r1 with AES 128 may be used for asymmetric keys.

The key generation may be done by sampling a noise source either on the platform or by requesting a string of bits from servers on the Internet that use quantum sources to generate random bit strings and provides those strings whenever requested. Such asynchronous sampling of true random bit sequences is superior to random functions typically provided as part of Operating System code. In addition, devices can use internal entropy to generate bit strings. In one preferred method, OpenSSL library may be used to generate keys and for cryptographic support. For voice support, PJSIP library may be used which internally uses OpenSSL.

In addition, the present system may not require support by advertisements and may be free of any backdoors.

According to one embodiment, the present secure communication application provides a variety of communication methods, including chat messaging session, voice call, and/or a group chat session between two or more users. The present secure communication application provides in-application text generation, audio generation, image generation, and video generation. The present secure communication application provides file sharing with support for various file types (e.g., an audio file, an image, and a video). A user may activate any method of communication (text, voice call, group chat, etc.) through the application on the device by touching an icon on the touch screen of the device. Group sessions may be managed as multiple peer-to-peer full mesh applications. In other embodiments, however, one device in the group may act as a hub for the other devices, and a central server may not be needed.

In certain embodiments, the communication application may allow the user to create a broadcast list that allows the user to send the same message to multiple users in listed in the broadcast list or contact list. In one embodiment, the users on the broadcast list will not know that the message was broadcast to multiple users as it will appear as having been sent only to the one user. In other embodiments, the broadcast list may be sent to all users on the broadcast list. Furthermore, depending on preference, any reply message sent in response to a broadcast message may only be sent to the user who sent the original message using the broadcast, or a reply all feature may be implemented so that all users on the broadcast list receive any reply messages.

According to one embodiment, the present secure communication application includes configurable settings that may be configured by a user. In one embodiment, the configurable settings include a configurable time period after which the present secure communication application automatically deletes all communication content. In another embodiment, the configurable settings include a configurable lock time after which the present secure communication application automatically locks the application and/or the device.

The present secure communication application may provide a user interface that allows a user to add a contact of another user to his/her contact list based on a text messaging service such as a short message service (SMS) and/or a secret key. The present secure communication application provides a self-destructing option by clearing all data and resetting the application with a particular gesture, according to one embodiment.

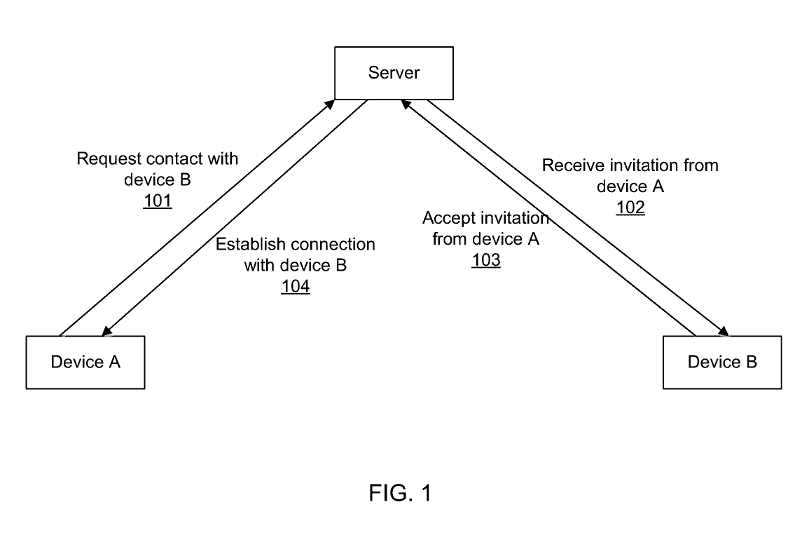

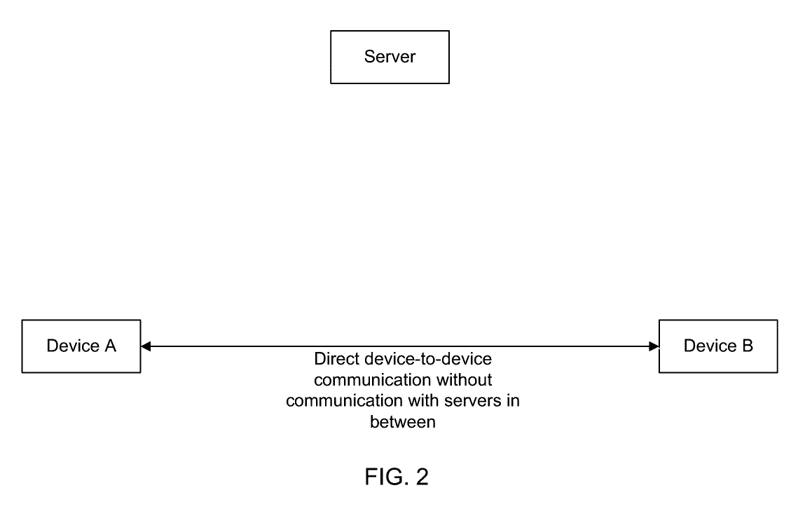

FIG. 1 and FIG. 2 illustrate exemplary diagrams for providing secure and anonymous device-to-device communication, according to one embodiment. Referring to FIG. 1, Device A connects with a server at 101 to request contact or pairing with device B. Device B receives an invitation to connect or pair with device A from the server at 102. Through an interface on device B, a user may accept or deny the invitation to pair with device A. Device B may respond to the server and accept the invitation to connect with device A at 103. The server may then communicate with device A the acceptance by device B, and then device A establishes a connection with device B via the server at 104. Thereafter, device A proceeds to communicate directly with device B, such as sending and/or receiving data (e.g., a text file, an audio file, an image, and a video) to and/or from device B without the need for communication with the server in between device A and device B, as shown in FIG. 2.

Direct connection over the Internet between devices is often thwarted by firewalls and network address translation (NAT) devices. The present communication application uses discovery processes whereby connection to the server also informs device A and device B of the public addressing parameters needed to do a direct connection. The initial invite process described herein also enables the pair of devices to exchange such direct addressing information needed to eliminate the server from both the signaling and media paths for true peer-to-peer operation. In certain embodiments, devices can discover their own addressing parameters by connecting to a server.

Any sent or received data using the communication application is stored in local memory on the device. This pairing process repeats for each pairing. In one embodiment, once two devices have been paired, the pairing process will no longer be required for feature communication, unless a device is removed from the contact list. It has been contemplated though that each communication session will require a new pairing process.

According to one embodiment, the present secure communication application provides a user interface that allows a user to configure one or more configurable settings. The configurable settings may include a configurable time period that allows the user to configure a length of time for a message to be seen or stored on a receiving device before the present communication application automatically deletes the message. For example, the user may configure the present system to delete a message after a desired time period of about 30 seconds, 1 minute, 5 minutes, 15 minutes, 1 hour, or 24 hours after the message has been opened by the receiving device. In other embodiments, the automatic deletion feature may delete a message or data after any amount of time and may even delete a message or data after any desired amount of time after the message is sent. Furthermore, the communication application may delete the message or data from both the sender and receiver's devices. In one embodiment, after the present communication application deletes a message to/from a second user on a first user's contact list, the user interface of the present secure communication application may display an indication on the first user's contact list that the message to/from the second user has been automatically deleted. The configurable settings may include a configurable mask that allows the user to choose a mask (e.g., an image) that is displayed to the user's contacts along with a desired name.

The configurable settings may include a configurable lock time that allows the user to set a time after which the present system automatically locks the communication application. The configurable settings may further include a configurable password that allows the user to configure a password that has to be provided to unlock the communication application. In one embodiment, fingerprint recognition or other types of biometrics may be used to unlock the communication application. For example, the user configures the present system to automatically lock the communication application after a desired time of 1 minute of inactivity. The lock time may be set to any amount of time including 30 seconds, 1 minute, 2 minutes, 5 minutes, 10 minutes, 15 minutes, or 30 minutes of inactivity. The configurable settings may allow the user to configure a status (e.g., online, offline) for the user that is displayed to other contacts on the user's contact list.

According to one embodiment, the present secure communication application allows a user to add contacts using a text messaging service (e.g., SMS). The present system allows a first user to invite a second user to connect with the first user by providing the second user's phone number and an invitation message to the second user, configuring a display name of the second user to be displayed on the first user's contact list, and requesting the second user to accept the invitation.

For example, Calvin requests to add Nick to Calvin's contact list in the present secure communication application by inputting Nick's phone number on the user interface. The present secure communication application receives Nick's phone number and prompts Calvin to configure a display name representing Nick to be displayed in Calvin's contact list and an invitation message (e.g., Hi, it's Calvin!) to be sent to Nick's user device. The present secure communication application sends an invitation request that includes the invitation message to Nick's user device. After Nick accepts the invitation request, the present secure communication application confirms the acceptance by displaying Nick's display name on Calvin's contact list and allows communication between Nick and Calvin.

According to one embodiment, the present secure communication application allows a user to add contacts using a secret key. The secret key may be generated using random numbers as described above. The secret key, sent over a secondary communications method, or in-person, when used to accept a time-limited invite, enables the direct peer-to-peer communication to boot-strap. Subsequent interactions discard this key as in a one-time pad and use new keys shared within encrypted peer-to-peer links to secure subsequent signaling interactions. The present secure communication application allows a first user to invite a second user to connect with the first user by providing the second user's secret key and configuring a display name of the second user to be displayed to the first user's contact list. According to one embodiment, the present secure communication application sends the second user's secret key to a text messaging service that then sends a message to the first user's user device.

Furthermore, devices may share their own addressing information when a user inputs a correct secret key (bootstrap code). In certain embodiment, the secret key or bootstrap code is rendered useless by the system after a desired amount of time as an additional security method. In one embodiment, a bootstrap code may only be used one time as in a one-time pad. It has been contemplated that the connected devices can update secret keys used to secure the secure peer-to-peer connection within the peer-to-peer direct connection at any time or continuously. Also, the signaling may differ from other Internet based applications in that it may be modified and simplified to not need an intervening proxy, B2BUA (back to back user agent), gateway, or other server intervening in the communication application session establishment, session operation, or session tear-down.

For example, the present secure communication application on Calvin's user device receives a message (e.g., an SMS) from Nick's user device that includes a secret key representing Nick. Calvin may add Nick to Calvin's contact list by inputting Nick's secret key on the user interface.

According to one embodiment, the present secure communication application automatically locks the application after a desired lock time. The present secure communication application allows a user to lock the application before the desired lock time expires by activating or tapping a lock button on the user interface. The present secure communication application allows the user to provide a password or biometric information (e.g., fingerprint) to unlock the application.

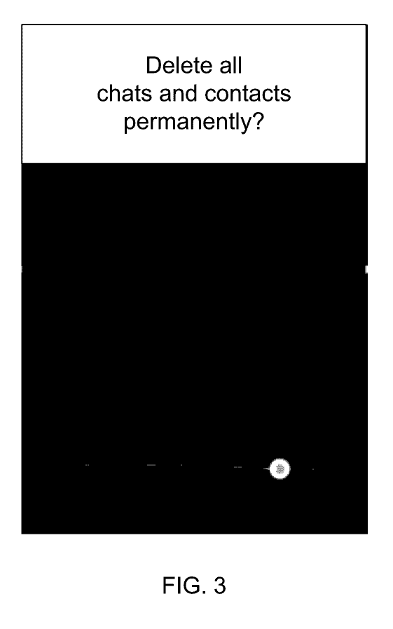

The present secure communication application may allow a user to quickly and easily clear or delete all chats and contacts from the memory on the device associated with the communication application, in one embodiment. The present secure communication application receives user input such as a touch input that includes a swipe from right to left on a screen. The present secure communication application prompts the user whether to delete all chats and contacts by tracing a particular shape (e.g., a z-shape) that is displayed on the screen. When the present secure communication application receives touch input that matches and traces the particular shape that is displayed on the user interface, the present secure communication application deletes all chats and contacts from memory. FIG. 3 illustrates an exemplary user interface for receiving touch input that traces a displayed z-shape, according to one embodiment. The user interface displays lines indicating the touch input that traces a display z-shape that is marked by dots.

In one embodiment, the present secure communication application may allow devices to communicate over a cloud based on a server provided by the present system. In another embodiment, the present secure communication application allows devices to communicate over a private cloud based on premise server hardware. In another embodiment, the present secure communication application allows devices to communicate over a private cloud based on a plug and play server solution for users that do not have on premise server hardware. In one embodiment, the light-weight servers that provide the introductions that bootstrap the peer-to-peer direct communication between devices can be operated by any organization and at any location, public or private, connected to the Internet, as desired by the customer group. The light-weight servers may allow those operations to be dispersed and not represent a single organization as a point of attack.

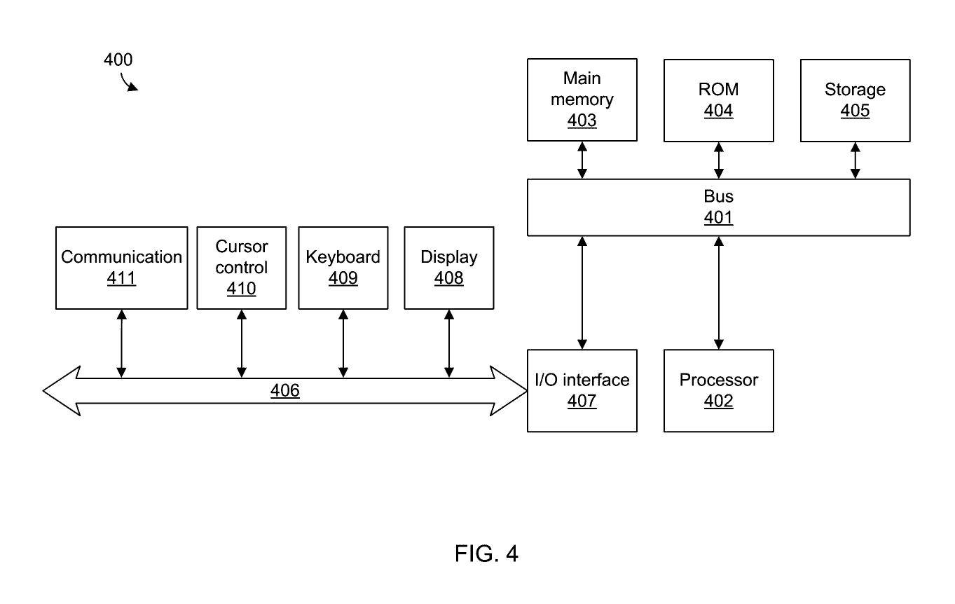

FIG. 4 illustrates an exemplary computer architecture that may be used for the present system, according to one embodiment. The exemplary computer architecture may be used for implementing one or more components, e.g., the server and mobile handset devices, described in the present disclosure including, but not limited to, the present system. One embodiment of architecture 400 includes a system bus 401 for communicating information, and a processor 402 coupled to bus 401 for processing information. Architecture 400 further includes a random access memory (RAM) or other dynamic storage device 403 (referred to herein as main memory), coupled to bus 401 for storing information and instructions to be executed by processor 402. Main memory 403 also may be used for storing temporary variables or other intermediate information during execution of instructions by processor 402. Architecture 400 may also include a read only memory (ROM) and/or other static storage device 404 coupled to bus 401 for storing static information and instructions used by processor 402.

A data storage device 405 such as a magnetic disk or optical disc and its corresponding drive may also be coupled to architecture 400 for storing information and instructions. Architecture 400 can also be coupled to a second I/O bus 406 via an I/O interface 407. A plurality of I/O devices may be coupled to I/O bus 406, including a display device 408, an input device (e.g., an alphanumeric input device 409 and/or a cursor control device 410).

The communication device 411 allows for access to other computers (e.g., servers or clients) via a network. The communication device 411 may include one or more modems, network interface cards, wireless network interfaces or other interface devices, such as those used for coupling to Ethernet, token ring, or other types of networks.

While the present disclosure has been described in terms of particular embodiments and applications, summarized form, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the scope of the present disclosure.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A method for providing secure communication between a first device and a second device, the method comprising:
establishing connections between the first device and a server and the second device and the server;
sending a request to the server from the first device to connect with the second device;
sending the request to connect with the second device from the server to the second device;
sending an acceptance of the request to connect from the second device to the server;
sending the acceptance of the request to connect from the server to the first device; and
establishing a direct connection between the first device and the second device without the need for communication with the server in between the first device and the second device.

2. The method of claim 1, further comprising downloading a communication application on the first device.

3. The method of claim 2, further comprising downloading the communication application on the second device.

4. The method of claim 3, wherein downloading the communication application from a privately available URL.

5. The method of claim 1, wherein the request to connect with the second device includes a phone number for the second device and an invitation message.

6. The method of claim 1, wherein the request to connect with the second device includes a secret key of the second device. The method of claim 1, wherein the server is a text messaging server.

8. The method of claim 1, further comprising encrypting all communications between the first and the second devices.

9. The method of claim 1, further comprising deleting all communications between the first and second devices after a specific amount of time.

10. The method of claim 1, further comprising deleting all communications and contacts from the first device at the request of the user.

11. The method of claim 10, wherein enabling a single swipe interface mechanism to delete all communications and contacts form the first device.

12. The method of claim 1, wherein the first and second devices can discover their own addressing parameters after establishing a connection with the server.

13. The method of claim 1, further comprising accessing the server, by the first and second devices to receive random bit strings.

14. The method of claim 1, further comprising generating bit strings using internal entropy of the first and second devices.

15. The method of claim 1, further comprising creating a secret key with the first and second devices by using a random bit string as one-time pad.

16. The method of claim 1, further comprising sharing addressing information between the first and second devices after receiving a correct bootstrap code.

17. The method of claim 16, further comprising rendering the bootstrap code useless within a desired time.

18. The method of claim 16, wherein the first and second devices use the bootstrap code in a one-time pad.

19. The method of claim 1, further comprising updating the addressing information as it changes on the first and second devices through the direct connection.

20. The method of claim 1, further comprising updating secret keys used to request the direct connection between the first and second devices within a secure direct connection.

21. The method of claim 1, wherein the direct connection supports voice, text, video, direct signaling, and media streams.

22. The method of claim 1, wherein the direct connection between the first and second devices does not require an intervening proxy, a back to back user agent, gateway, or other server intervening in establishing the direct connection, operating the direct connection, or tearing down the direct connection.

23. The method of claim 1, further comprising establishing a group session by establishing a direct connection between the first and second devices and a third device.

24. The method of claim 23, further comprising managing the group session as multiple direct connections full mesh applications.

25. The method of claim 23, wherein the group session is managed by using the first device as a hub for the second and third devices.

26. A system for secure communication, comprising:
a first device operating a communication application;
a second device operating the communication application; and
a server in communication with the first device and the second device;
wherein the first device sends a request to the server to connect with the second device, and the server relays the request to connect to the second device;
wherein the second device sends an acceptance of the request to connect to server, the server relays the acceptance to connect to the first device, and a direct connection is established between the first device and the second device.

27. The system of claim 26, wherein the user of the first device remains anonymous to the user of the second device.

28. The system of claim 26, wherein the communication application is downloaded from a privately available URL onto the first and second devices.

29. The system of claim 26, wherein the request to connect with the second device includes a phone number for the second device and an invitation message.

30. The system of claim 26, wherein the request to connect with the second device includes a secret key of the second device.

31. The system of claim 26, wherein the server is a test messaging server.

32. The system of claim 26, wherein all communications between the first and the second devices are encrypted.

33. The system of claim 26, wherein the first device stores communications between the first and second devices in memory and deletes communications between the first and second devices after a specific amount of time.

34. The system of claim 26, wherein the first device locks the communication application after a specific amount of time.

35. The system of claim 26, wherein the first and second devices may communicate through the communication application using text messaging or voice calls.

36. The system of claim 26, wherein the first and second devices may send rich communication content or share files through the communication application.
